(19) United States
(12) Patent Application Publication
(10) Pub. No.: US 2014/0183219 A1
(43) Pub. Date: Jul. 3, 2014

(54) VENDING MACHINE

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: YUN-LUNG CHEN, New Taipei (TW); LI TONG, Wuhan (CN); HAI-TAO SHAN, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/015,115

(22) Filed: Aug. 30, 2013

(30) Foreign Application Priority Data
Dec. 29, 2012 (CN) 2012105891018

(51) Int. Cl. G07F 11/02

(52) U.S. Cl. CPC G07F 11/02
USPC 221/306

(57) ABSTRACT

A vending machine includes a mounting bracket and a balance assembly. The mounting bracket includes two side panels and a cover panel pivotably mounted between the two side panels. The balance assembly includes a loading arm, a loading panel secured to the loading arm, and a balance member secured to the loading arm. The loading arm is pivotably mounted between the two side panels. The loading panel and the balance member are mounted to opposite sides of the loading arm to maintain the loading panel in a first position. The loading panel includes a panel body and an engaging member. The engaging member blocks the cover panel from rotating inward. The loading panel rotates from the first position to a second position after a product is dropped on the loading panel, and the engaging member is moved down to unblock the cover panel.

### BACKGROUND

1. Technical Field

The present disclosure relates to a vending machine capable of securing the product output opening.

2. Description of Related Art

A vending machine has an output opening from which customers can fetch a product. However, the output opening can be easily broken. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a vending machine.

FIG. 2 is similar to FIG. 1, but viewed from another aspect.

FIG. 3 is an assembled view of the vending machine of FIG. 1.

FIG. 4 is a cross-sectional view of the vending machine of FIG. 3 taken along line IV-IV.

FIG. 5 is a cross-sectional view of the vending machine of FIG. 3 taken along line IV-IV, with a product loading on the loading panel.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

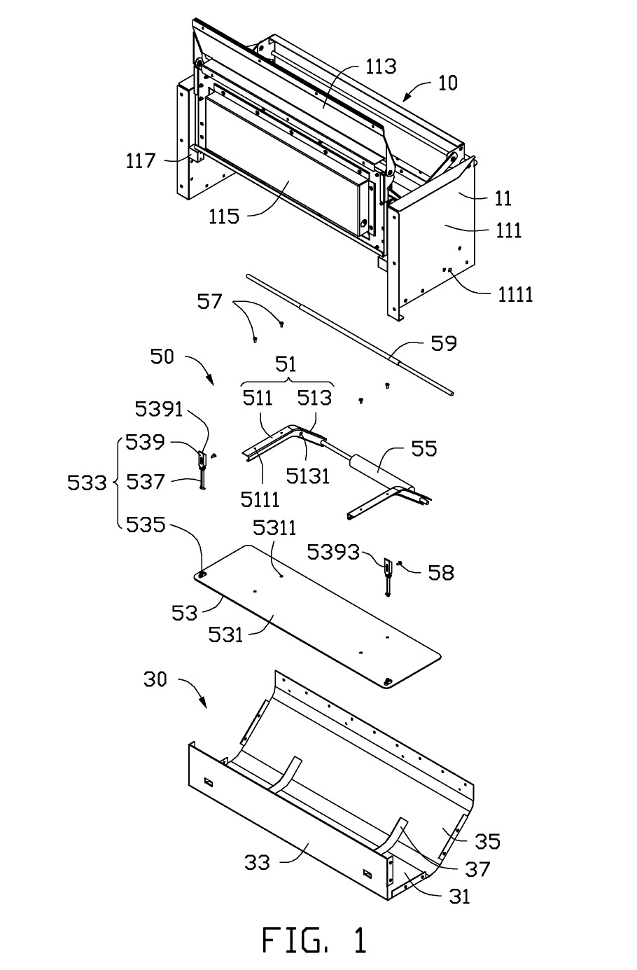

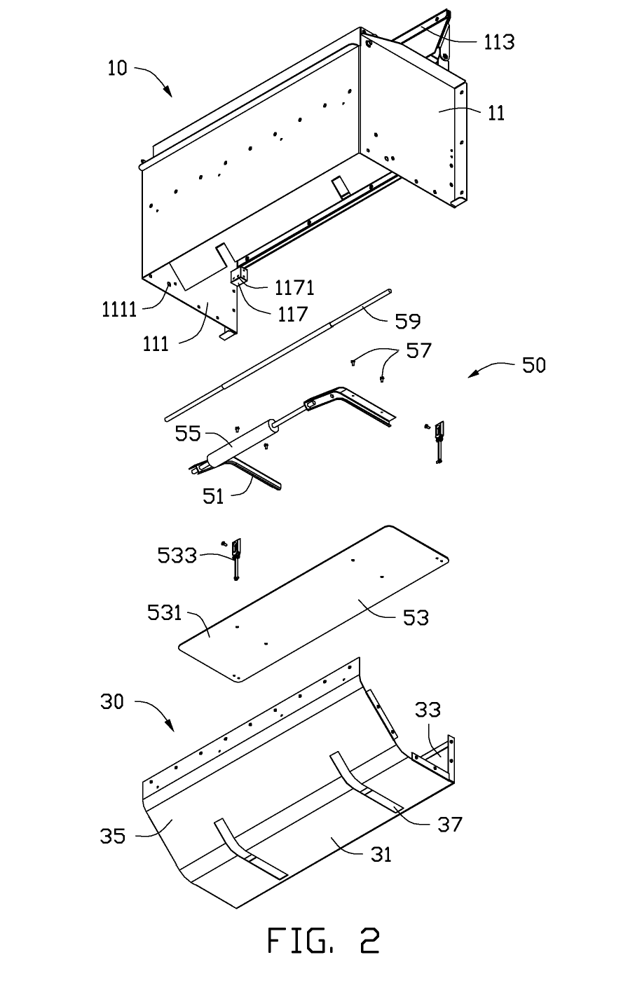

FIGS. 1 and 2 show that a vending machine, according to one embodiment, includes a mounting bracket 10, a mounting base 30, and a balance assembly 50.

The mounting bracket 10 includes a bracket body 11, and a cover panel 115 pivotably mounted to the bracket body 11. The bracket body 11 includes two side panels 111, and a connecting member 113 connected between the two side panels 111. The side panels 111 are substantially parallel to each other. The cover panel 115 is pivotably mounted to the connecting member 113. The cover panel 115 is located between the two side panels 111. Each side panel 111 defines a pivot hole 1111. The mounting bracket 10 further includes a mounting protrusion 117 secured on an inner side of each side panel 111. The mounting protrusion 117 defines a mounting hole 1171.

The mounting base 30 includes a bottom wall 31, a front wall 33 extending from the bottom wall 31, and a rear wall 35 slantingly extending from the bottom wall 31. The mounting base 30 defines two elongated openings 37. The elongated openings 37 run along the bottom wall 31 and the front wall 33.

The balance assembly 50 includes two loading arms 51, a loading panel 53 secured to the two loading arms 51, and a balance member 55 connected between the two loading arms 51. Each loading arm 51 includes a loading portion 511, and a balance portion 513 slantingly connected to the loading portion 511. The balance member 55 is secured between the two balance portions 513. Each balance portion 513 defines a rotating hole 5131. Each loading portion 511 defines two through holes 5111.

The loading panel 53 includes a panel body 531, and two engaging members 533 secured to the panel body 531. Each engaging member 533 includes a securing portion 535 secured to the panel body 531, a connecting shaft 537 pivotably mounted to the securing portion 535, and a fastening portion 539 pivotably mounted to the connecting shaft 537. The fastening portion 539 defines an inclining surface 5391 and a sliding slot 5393. The panel body 531 defines four securing holes 5311.

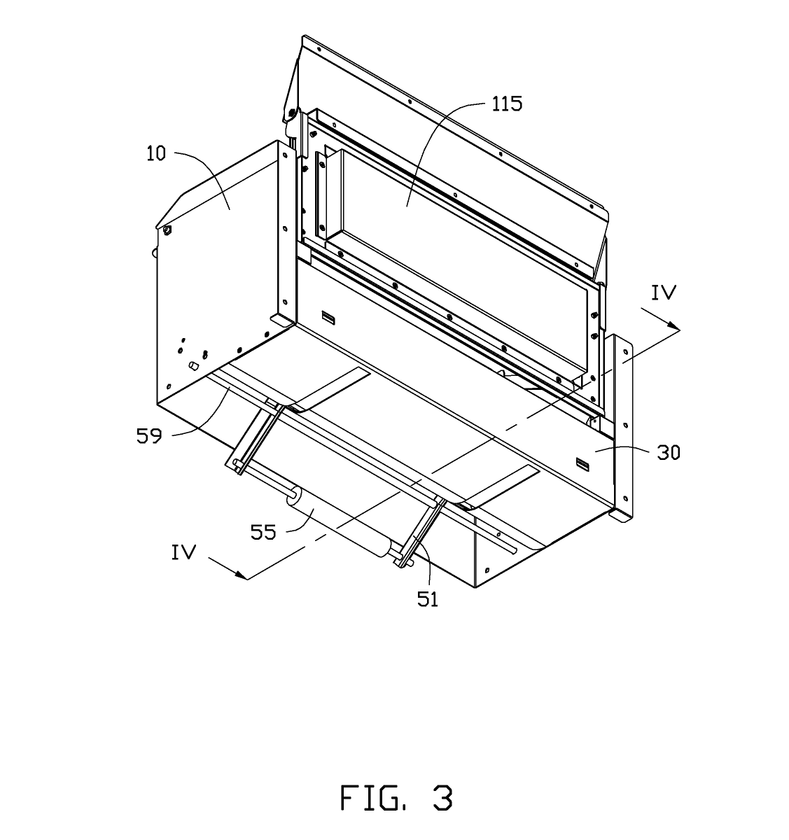

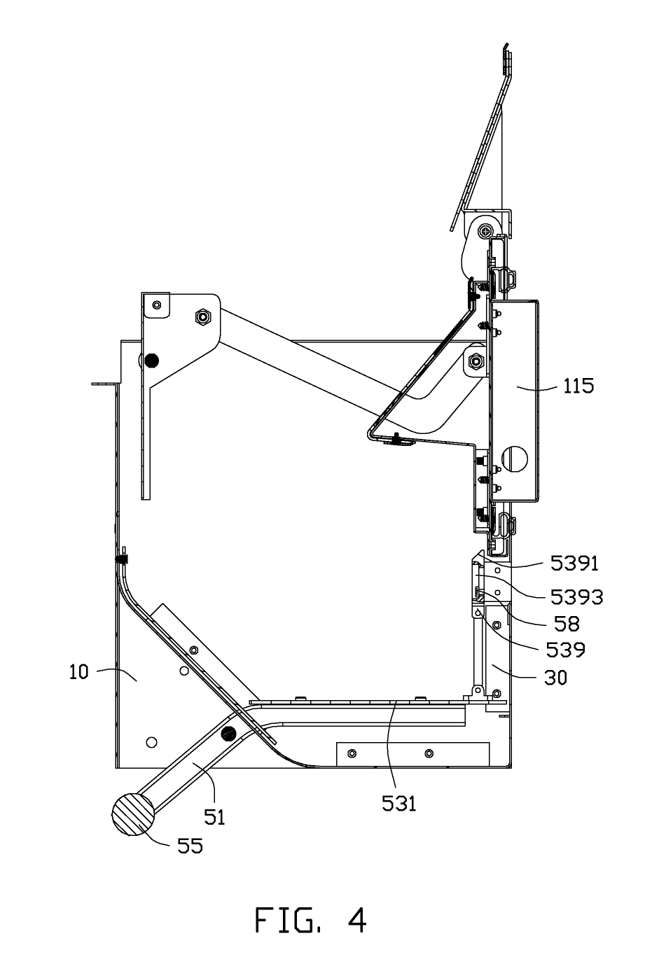

FIGS. 3 and 4 show that in assembly, the two loading arms 51 are received by the two elongated openings 37 of the mounting base 30, such that the balance member 55 is located out of the mounting base 30. The loading panel 53 is placed on the two loading arms 51, such that the securing holes 5311 are aligned with the through holes 5111. The four first fasteners 57 are secured in the securing holes 5311 and the corresponding through holes 5111 to secure the loading panel 53 to the two loading arms 51. The mounting bracket 10 is placed on the mounting base 30. A plurality of screws (not shown) secures the mounting bracket 10 to the mounting base 30. A pivot shaft 59 passes through the rotating holes 5131 and the pivot holes 1111 of the mounting bracket 10, such that the balance assembly 50 is pivotably mounted to the mounting bracket 10. At this time, the loading portions 511 of the loading arms 51 are substantially parallel to the bottom wall 31 of the mounting base 30, and the two fastening portions 539 abut the two mounting protrusions 117 of the mounting bracket 10. The sliding slots 5393 of the fastening portions 539 are aligned with the mounting holes 1171 of the two mounting protrusions 117. Two second fasteners 58 are secured in the sliding slots 5393 and the corresponding mounting holes 1171, such that the fastening portions 539 are slidably mounted to the mounting protrusions 117. At this time, the two fastening portions 539 block the cover panel 115 to prevent the cover panel 115 from moving inward.

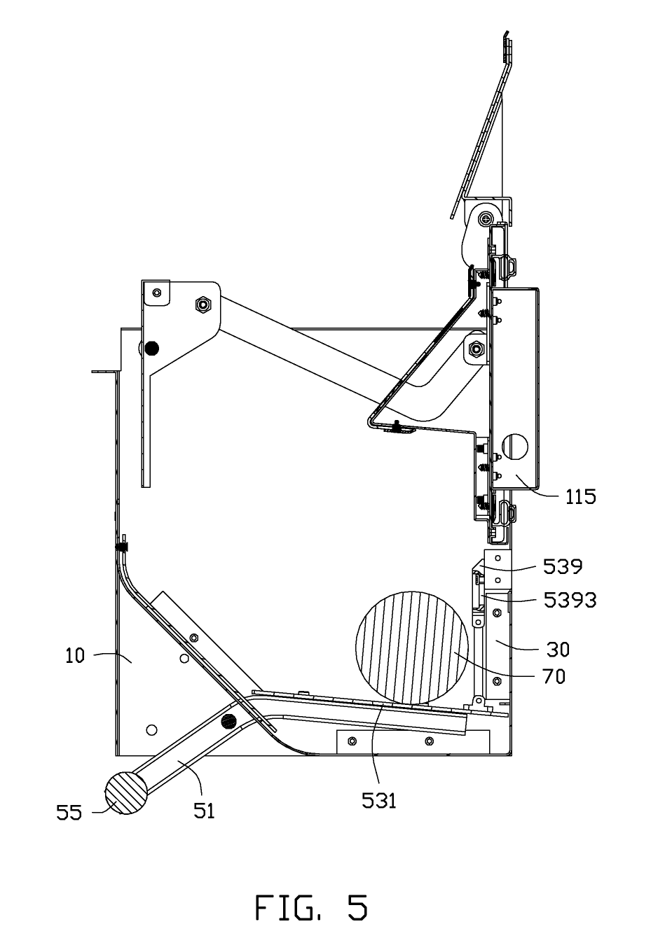

FIGS. 4 and 5 show that when a product 70 drops on the loading panel 53, the loading panel 53 rotates downward because of the weight of the product 70, thereby driving the fastening portions 539 to slide downward to unblock the cover panel 115. After the fastening portions 539 unblocks the cover panel 115, a customer pushes the cover panel 115 inward to fetch the product 70. After the product 70 is taken out of the vending machine, the weight of the balance member 55 rotates the loading panel 53 back to its original position, and the weight of the cover panel 115 rotates the cover panel 115 outward. When the cover panel 115 rotates outward, the cover panel 115 resists the inclining surfaces 5391 of the fastening portions 539 to drive the fastening portions 539 downward. When the cover panel 115 returns to its original position, the fastening portions 539 moves back to block the cover panel 115 again.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A vending machine comprising:
a mounting bracket, the mounting bracket comprises two side panels and a cover panel pivotably mounted between the two side panels; and
a balance assembly, the balance assembly comprises a loading arm, a loading panel secured to the loading arm, and a balance member secured to the loading arm; the loading arm is pivotably mounted between the two side panels; the loading panel and the balance member are mounted to opposite sides of the loading arm to maintain the loading panel to be in a first position; the loading panel comprises a panel body and an engaging member secured to the panel body; and the engaging member is configured to block the cover panel to prevent the cover panel from rotating inward, and the loading panel is configured to rotate from the first position to a second position after loading a product to drive the engaging member to move down to unblock the cover panel.

2. The vending machine of claim 1, wherein the engaging member comprises a fastening portion slidably mounted to the mounting bracket; the fastening portion defines an inclining surface; the cover panel is configured to move back from a current position to an original position, driven by the weight of the cover panel, to resist the inclining surface to drive the fastening portion to slide down after being pushed to rotate inward to the current position; and <remember your ands> the balance member is configured to drive the loading panel to rotate upward to the first position when there is no external force applied to the loading panel.

3. The vending machine of claim 2, wherein the engaging member further comprises a connecting shaft pivotably mounted to the fastening portion and a securing portion pivotably mounted to the connecting shaft, and the securing portion is secured to the panel body.

4. The vending machine of claim 2, wherein the fastening portion defines a sliding slot; the mounting bracket comprises a mounting protrusion secured to one of the two side panels; the mounting protrusion defines a mounting hole; and a fastener passes through the sliding slot to be secured in the mounting hole to secure the fastening portion to the mounting protrusion.

5. The vending machine of claim 1, wherein the loading arm comprises a loading portion and a balance portion extending from the loading portion; the loading panel is secured to the loading portion; and the balance member is secured to the balance portion.

6. The vending machine of claim 5, further comprising a pivot shaft, wherein the balance portion defines a rotating hole; the loading panel and the balance member are located on two sides of the rotating hole; each of the two side panels defines a pivot hole corresponding to the rotating hole; and the pivot shaft passes through the rotating hole and the two pivot holes to enable the loading arm to be pivotably mounted between the two side panels.

7. The vending machine of claim 1, further comprising a mounting base, wherein the mounting base comprises a bottom wall, a front wall extending from the bottom wall, and a rear wall extending from the bottom wall; the mounting base defines an elongated opening in a connecting portion between the bottom wall and the rear wall; the loading arm is received in the elongated opening; and the balance member is located on an outer side of the mounting base.

8. The vending machine of claim 7, wherein the rear wall extend slantly from the bottom wall.

9. The vending machine of claim 7, wherein the loading panel is substantially parallel to the bottom wall when the loading panel is in the first position.

10. A vending machine comprising:
a mounting bracket, the mounting bracket comprises two side panels and a cover panel pivotably mounted between the two side panels; and
a balance assembly, the balance assembly comprises two loading arms, a loading panel secured to the two loading arms, and a balance member secured between the two loading arms; the two loading arms are pivotably mounted between the two side panels; the loading panel comprises a panel body and an engaging member secured to the panel body and slidably mounted to the mounting bracket; the engaging member is configured to block the cover panel to prevent the cover panel from rotating inward when the loading panel is in a first position; the loading panel is configured to rotate downward from the first position to a second position after receiving a force to drive the engaging member to move down to unblock the cover panel; and the balance member is configured to drive the loading panel to rotate back to the first position because of the weight of the balance member when there is no force is applied to the loading panel.

11. The vending machine of claim 10, wherein the engaging member comprises a fastening portion slidably mounted to the mounting bracket; the fastening portion defines an inclining surface; and the cover panel is configured to move back from a current position to an original position, driven by the weight of the cover panel, to resist the inclining surface to drive the fastening portion to slide down after being pushed to rotate inward to the current position.

12. The vending machine of claim 11, wherein the engaging member further comprises a connecting shaft pivotably mounted to the fastening portion and a securing portion pivotably mounted to the connecting shaft, and the securing portion is secured to the panel body.

13. The vending machine of claim 11, wherein the fastening portion defines a sliding slot; the mounting bracket comprises a mounting protrusion secured to one of the two side panels; the mounting protrusion defines a mounting hole; and a fastener passes through the sliding slot to be secured in the mounting hole to secure the fastening portion to the mounting protrusion.

14. The vending machine of claim 10, wherein each of the two loading arms comprises a loading portion and a balance portion extending from the loading portion; the loading panel is secured to the two loading portions; and the balance member is secured to the two balance portions.

15. The vending machine of claim 14, further comprising a pivot shaft, wherein the balance portion defines a rotating hole; the loading panel and the balance member are located on two sides of the rotating hole; each of the two side panels defines a pivot hole corresponding to the rotating hole; the pivot shaft passes through the rotating hole and the two pivot holes to enable the two loading arms to be pivotably mounted between the two side panels.

16. The vending machine of claim 10, further comprising a mounting base, wherein the mounting base comprises a bottom wall, a front wall extending from the bottom wall, and a rear wall extending from the bottom wall; the mounting base defines two elongated openings in a connecting portion between the bottom wall and the rear wall; the two loading arms is received in the two elongated openings; and the balance member is located on an outer side of the mounting base.

17. The vending machine of claim 16, wherein the rear wall extend slantly from the bottom wall.

18. The vending machine of claim 16, wherein the loading panel is substantially parallel to the bottom wall when the loading panel is in the first position.
